(19) United States
(12) Patent Application Publication
(10) Pub. No.: US 2012/0142337 A1
(43) Pub. Date: Jun. 7, 2012

(54) TEMPORARY ACTIVATION OF INTER-RAT FEATURES IN BASE STATIONS

(76) Inventors: Jin Wang, Lisle, IL (US); Marie Divialle, Bures sur Yvette (FR)

(21) Appl. No.: 12/958,659

(22) Filed: Dec. 2, 2010

(51) Int. Cl. H04W 24/00

(52) U.S. Cl. 455/424

(57) ABSTRACT

Systems and methods are disclosed for temporarily activating inter-RAT features in neighboring base stations when a base station becomes out of service. A system in one embodiment receives a notification message from a base station that the base station becomes out of service. The system then identifies other base stations that are neighbors of the out-of-service base station, and generates instructions to activate inter-RAT features in the neighboring base stations while the base station is out of service. The system then transmits the instructions to the neighboring base stations to activate the inter-RAT features. When the base station becomes operational again, the system deactivates the inter-RAT features in the neighboring base stations.

### FIELD OF THE INVENTION

The invention is related to the field of communications. More particularly, when a base station is taken out of service, inter-Radio Access Technology (inter-RAT) features or capabilities are temporarily activated in neighboring base stations to provide wireless service to mobile devices within the cell of the base station.

### BACKGROUND

Mobile networks presently operate according to 2^{nd} Generation (2G) or 3^{rd} Generation (3G) standards to provide voice and data services. The trend for mobile networks is to evolve towards 4^{th} Generation (4G) technologies. One project within the 3rd Generation Partnership Project (3GPP, 3GPP2) is the Long Term Evolution (LTE), which is a 4G technology intended to provide data rates of 100 mbps or more. The network architecture defined by this project is referred to as the Evolved Packet System (EPS). The EPS architecture comprehends e-UTRAN (evolved-UMTS Terrestrial Radio Access Network) on the radio access side and EPC (Evolved Packet Core) on the core side.

e-UTRAN is the air interface of the LTE network, and comprises a plurality of base stations that are referred to as Enhanced NodeBs (eNodeBs). NodeB is a term used in UMTS to refer to a base station or cell site that interfaces a mobile device with a core network (similar to a base transceiver station (BTS) in a GSM network). A base station includes antennas that communicate with mobile devices that are within a certain range. The coverage area surrounding the base station is referred to as a “cell”. An eNodeB is comprised of multiple cells or sectors and is an enhanced base station that performs tasks similar to a nodeB in communicating with mobile devices.

LTE standards, such as 3GPP Technical Specification (TS) 36.331, allow an eNodeB to take itself out of service and suspend wireless service within its cell. This is typically referred to as “cell-barring”. There are a variety of situations where an eNodeB implements cell-barring. For example, an eNodeB may be scheduled for maintenance, a software update, a hardware update, etc. Also, an eNodeB may dynamically detect problems, such as connectivity between the eNodeB and a Mobility Management Entity (MME). When an eNodeB implements cell-barring, the eNodeB announces its unavailability in a System Information Message to mobile devices within its cells. The mobile devices that receive the System Information Message will exclude the barred cell as a candidate for cell selection.

One problem that occurs when an eNodeB triggers or invokes cell-barring is that a coverage hole may be created in the overall service area of the LTE network. Some mobile devices in the area may be able to receive (4G) service from neighboring eNodeB's, but others can move toward the coverage hole and thus may not be close enough to the neighboring eNodeB's at a certain point in time to receive the wireless service. Thus, some mobile devices may experience an interruption in wireless service or LTE “call drops”.

### SUMMARY

Embodiments described herein temporarily activate inter-Radio Access Technology (inter-RAT) features in neighboring base stations when a base station is taken out of service (e.g., cell-barring). Inter-RAT features refer to capabilities that allow for a transfer in wireless service from one RAT to another. For example, the wireless service may transfer from an LTE network to a UMTS network, from an LTE network to a GSM network, from an LTE network to a CDMA EVDO network, or from an LTE network to a CDMA 1xRTT network. When multiple RAT services are available to a mobile device, a base station may broadcast one or multiple types of System Information Messages to the affected mobile devices for the purposes of cell reselection and redirecting/handing over wireless service to another RAT network. Thus, the mobile devices in a cell of the barred base station may temporarily receive wireless service through another RAT network while the barred base station is out of service. The wireless service available through another RAT network may be a downgrade in service (e.g., from 4G to 3G/2G), but the mobile device will still have some type of wireless service available.

In addition to activating inter-RAT features, the neighboring base stations may be instructed to add the barred base station to an intra-network handover blacklist, which is communicated to the mobile devices to prevent intra-network handover from a neighboring base station to the barred base station. The neighboring base stations may set up an inter-RAT measurement configuration with the mobile devices in preparation for inter-RAT handover/mobility that may occur if a mobile device continues to move toward any cell of the barred base station.

One embodiment comprises a network management system of a mobile network. The network management system includes an interface system operable to receive a notification message from a base station of the mobile network that the base station is out of service. The network management system further includes a control system operable to identify other base stations in the mobile network that are neighbors of the base station which is out of service, and to generate instructions to activate inter-RAT features in the neighboring base stations while the base station is out of service. The interface system is further operable to transmit the instructions to the neighboring base stations to activate the inter-RAT features.

In another embodiment, the interface system is operable to receive another notification message from the base station indicating that the base station is operational. The control system is operable to generate instructions to deactivate the inter-RAT features in the neighboring base stations, and the interface system is operable to transmit the instructions to the neighboring base stations to deactivate the inter-RAT features.

In yet another embodiment, the control system may be further operable to generate instructions to update an intra-network handover blacklist for mobile devices that are connected on a session by adding cell IDs of the base station which is out of service. When the base station is operational again, the control system may generate instructions to update the intra-network handover blacklist by removing cell IDs of the base station which is now operational.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a mobile network in an exemplary embodiment.

FIG. 2 is a flow chart illustrating a method of activating inter-RAT features in neighboring base stations in an exemplary embodiment.

FIG. 3 is a flow chart illustrating a method of deactivating inter-RAT features in neighboring base stations in an exemplary embodiment.

FIG. 4 illustrates an LTE network in an exemplary embodiment.

FIG. 5 is a message diagram illustrating activation of inter-RAT features and update of an intra-LTE handover blacklist in neighboring eNodeBs in an exemplary embodiment.

FIG. 6 is a message diagram illustrating deactivation of inter-RAT features and update of the intra-LTE handover blacklist in neighboring eNodeBs in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

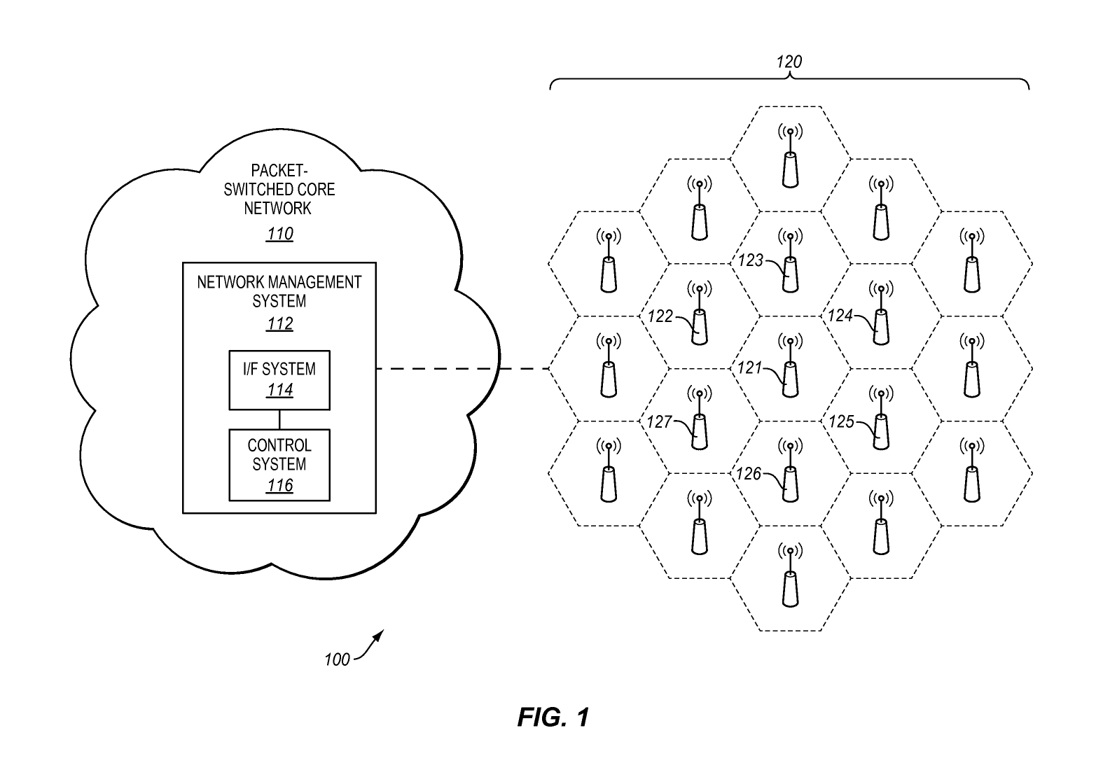

FIG. 1 illustrates a mobile network 100 in an exemplary embodiment. Mobile network 100 includes a packet-switched core network 110 connected to a plurality of base stations 120. Mobile network 100 may comprise an LTE network, where packet-switched core network 110 comprises an EPC network and base stations 120 comprise eNodeBs, or may comprise any other type of mobile network having a packet-switched core. Each of base stations 120 forms one or more cells within mobile network 100. The cell represents a coverage area where mobile devices (not shown) are able to exchange wireless signals with a base station. The cells in FIG. 1 are represented by hexagons surrounding each of the base stations 120.

Packet-switched core network 110 includes a network management system 112. In the embodiments described below, when one of the base stations 120 is taken out of service, network management system 112 is able to temporarily activate inter-RAT features in one or more neighboring base stations 120. To do so, network management system 112 includes an interface (I/F) system 114 that is operable to communicate with base stations 120. Network management system 112 further includes a control system 116 that is operable to determine the base stations 120 in which to activate the inter-RAT features, and to generate the appropriate instructions for activation. Packet-switched core network 110 may include other network elements that are not shown for the sake of brevity.

Assume for this embodiment that one of base stations 121 has been taken out of service. For example, base station 121 may be scheduled for maintenance, a software update, a hardware update, etc., or may detect service-impacting problems, such as a connectivity problem with another network element. When base station 121 is taken out of service, this action may be referred to as cell-barring. After invocation of cell-barring, base station 121 transmits a notification message to network management system 112 indicating that base station 121 has been taken out of service. Base station 121 may also announce its unavailability in a System Information Message to mobile devices within its cells.

The cell-barring of base station 121 may create a coverage hole in the overall coverage area of mobile network 100. Thus, mobile devices that are within the cell of base station 121 may not be able to receive wireless service. If a mobile device is connected on a call, then the call will be dropped if it continues to move toward base station 121. If a mobile device is in idle mode, then base station 121 will not be available for cell selection. To overcome the problems, network management system 112 temporarily activates inter-RAT features in neighboring base stations so that mobile devices in proximity to base station 121 may still receive some type of wireless service even as they move toward base station 121.

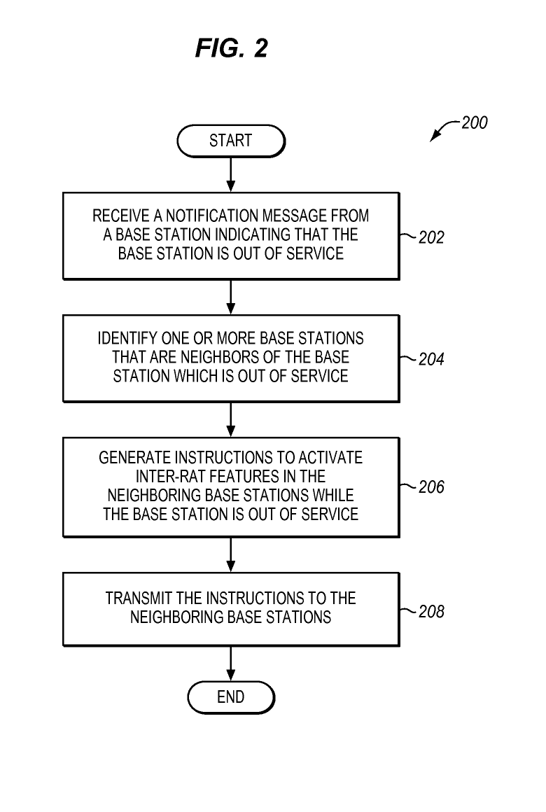

FIG. 2 is a flow chart illustrating a method 200 of activating inter-RAT features in neighboring base stations in an exemplary embodiment. The steps of method 200 will be described with reference to network management system 112 in FIG. 1, but those skilled in the art will appreciate that method 200 may be performed in other networks and systems. The steps of the flow charts described herein are not all inclusive and may include other steps not shown. The steps may also be performed in an alternative order.

In step 202, interface system 114 receives the notification message from base station 121 indicating that base station 121 is out of service. In response to the notification message, control system 116 identifies one or more other base stations 122-127 that are neighbors of base station 121 (in step 204). A neighbor refers to a base station that is next to or bordering the cell(s) of another base station, such as where a seamless Hand Over (HO) is possible. The base stations 122-127 abutting base station 121 are referred to as “neighboring” base stations.

There are a variety of ways that control system 116 may identify the neighbors of base station 121. In one example, control system 116 may be pre-provisioned with a look-up table that defines geographic relationships among the base stations 120 of mobile network 100. Control system 116 may process the notification message received from base station 121 to identify cell identifiers (IDs) for base station 121. Control system 116 may then access the look-up table using each of the cell IDs for base station 121 to identify other cell IDs that are defined as neighboring cells to this particular cell ID.

After identifying the neighboring base stations 122-127 in step 204, control system 116 generates instructions (in step 206) to activate inter-RAT features in neighboring base stations 122-127 while base station 121 is out of service. One assumption is that inter-RAT features may not be presently activated in all of neighboring base stations 122-127. Thus, the instructions comprise any commands or other data that direct the base stations to trigger inter-RAT features. The instructions may include commands to: Start broadcasting a particular type(s) of System Information Message or update some of the data as necessary (if the broadcast is already on-going); and set up inter-RAT measurement configurations with the connected mobile devices. Interface system 114 then transmits (in step 208) the instructions to neighboring base stations 122-127 to activate the inter-RAT features in neighboring base stations 122-127.

Neighboring base stations 122-127 then process the instructions, and activate the inter-RAT features accordingly. For example, the instructions may include commands for neighboring base stations 122-127 to broadcast a particular type of System Information Message to mobile devices for inter-RAT cells (re)selection purposes. In one example, if mobile network 100 comprises an LTE network, then the System Information Message broadcast to the mobile devices may include a System Information Block type 6 (SIB6) relevant to a UMTS network. In another example, the System Information Message broadcast to the mobile devices may include a SIB7 relevant to a GSM network. In another example, the System Information Message broadcast to the mobile devices may include a SIB8 relevant to a CDMA network (EVDO and/or 1xRTT).

The neighboring base stations 122-127 may also create a blacklist that includes the cell IDs of base station 121 which are excluded from cell selection for intra-network HO purposes, and send the blacklist to connected mobile devices. When base station 122 (or other neighboring base stations 123-127) is to set up cell measurements with a mobile device in connected mode, base station 122 may specify the blacklist to the mobile device to restrict intra-network (e.g., intra-LTE) handovers to the barred cells. This means the mobile device configured with the blacklist does not perform cell measurements on the cell IDs specified in the blacklist for the purpose of intra-network HO. The blacklist will include the cell identifiers for base station 121, which is temporarily out of service and is not available for serving incoming handover requests. If the mobile device moves toward base station 121, the mobile device does not measure the cells of base station 121 for intra-network handover purposes because the cells of base station 121 are part of the blacklist and are excluded.

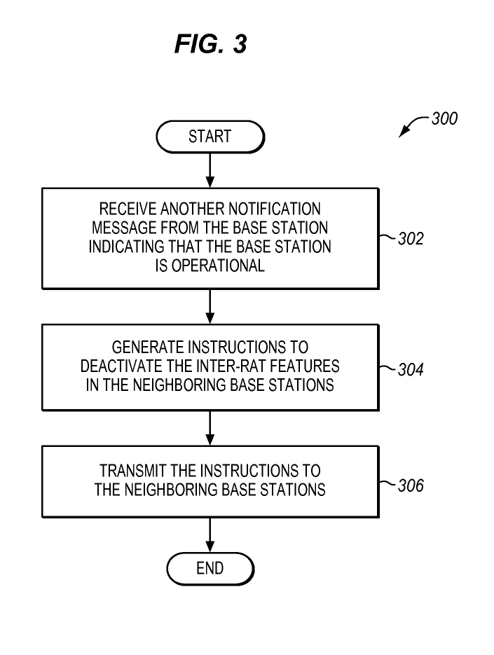

The inter-RAT features are activated temporarily in neighboring base stations 122-127 while base station 121 is out of service. However, when base station 121 is operational again (i.e., no longer out of service or cell-barred), base station 121 will again send a notification message to network management system 112 indicating that base station 121 is operational and is no longer out of service. Network management system 112 then sends instructions to deactivate the inter-RAT features in neighboring base stations as described in FIG. 3.

FIG. 3 is a flow chart illustrating a method 300 of deactivating inter-RAT features and in neighboring base stations 122-127 in an exemplary embodiment. In step 302, interface system 114 receives the notification message from base station 121 indicating that base station 121 is operational. In response to the notification message, control system 116 generates instructions to deactivate the inter-RAT features in neighboring base stations 122-127 in step 304. Interface system 114 then transmits the instructions to neighboring base stations 122-127 in step 306. The instructions from network management system 112 may include commands to: Stop broadcasting a particular type(s) of System Information Message (if the SIB type was not present prior to the activation of inter-RAT features) or update some of the data as necessary (if the SIB broadcast was previously on-going prior to activation of the inter-RAT features), and stop setting up inter-RAT measurement configurations with the same mobile devices.

Neighboring base stations 122-127 then process the instructions, deactivate the inter-RAT features accordingly. For example, the instructions may include commands for neighboring base stations 122-127 to stop broadcasting a particular type of System Information Message to mobile devices, to stop adding the un-barred cell IDs in a blacklist when setting up intra-network measurement configurations with connected mobile devices, and to stop setting up inter-RAT measurement configurations with the same mobile devices. The combined effect is to move mobile devices back to the original wireless service.

In addition to activating inter-RAT features in neighboring base stations 122-127, network management system 112 may also instruct neighboring base stations 122-127 to update an intra-network handover (HO) blacklist that is broadcast to and/or configured with mobile devices. Base stations 122-127 are able to broadcast blacklists indicating cells that are unavailable for cell selection. Base stations 122-127 are also able to use the blacklist to set up measurement configurations with connected mobile devices via dedicated base station-to-UE messages. Thus, when base station 121 is taken out of service, control system 116 may further generate instructions to update the intra-network HO blacklist for mobile devices that are connected on a call/session to add the cell IDs of base station 121, as well as to broadcast blacklist info to mobile devices in the idle mode. For example, the instructions may include a command to add the barred cell IDs for base station 121 to the blacklist when setting up intra-network HO measurement configurations with mobile devices in connected mode (they can continue to move toward the barred cells). These instructions may be sent along with the inter-RAT instructions described above.

When base station 121 is operational again, control system 116 may again generate instructions that update the intra-network HO blacklist to no longer add the cell IDs of base station 121 or remove the cell IDs. For example, the instructions may include a command to remove cell IDs for base station 121 from the blacklist when setting up intra-network HO measurement configurations with mobile devices in connected mode. The instructions may include another command to remove cell IDs for base station 121 from the blacklist when broadcasting blacklist information to mobile devices in idle mode.

As described FIGS. 1-3, network management system 112 is able to temporarily activate inter-RAT features in certain base stations and provide the collection of cell IDs of a given base station for blacklisting purposes. In FIG. 1, assume that a mobile device is located within the cell of base station 121, and that base station 121 is taken out of service. Network management system 112 is able to temporarily activate inter-RAT features, as needed, in the neighboring base stations 122-127 so that wireless service will be offered to the mobile device through a different RAT network. The wireless service available through the different RAT network may be a downgrade in service (e.g., from 4G to 3G/2G), but the mobile device will advantageously have some type of wireless service available.

When inter-RAT features are temporarily activated, there may be licensing fees that apply. To track the licensing fees, control system 116 may generate reports on the actual usage of inter-RAT features that are activated. For example, control system 116 may record the duration of time in which the inter-RAT features are activated in neighboring base stations 122-127. Control system 116 may also record the additional number of neighboring base stations 122-127 in which the inter-RAT features are temporarily activated, excluding those of base station 122-127 that were already activated prior to base station 121 having an out-of-service or barring event. Control system 116 may then generate an actual usage report indicating where the inter-RAT features were activated and for how long. The licensing fees for the temporary activation of the inter-RAT features may then be resolved and settled between the service provider and the network vendor based on the actual usage report.

### Examples

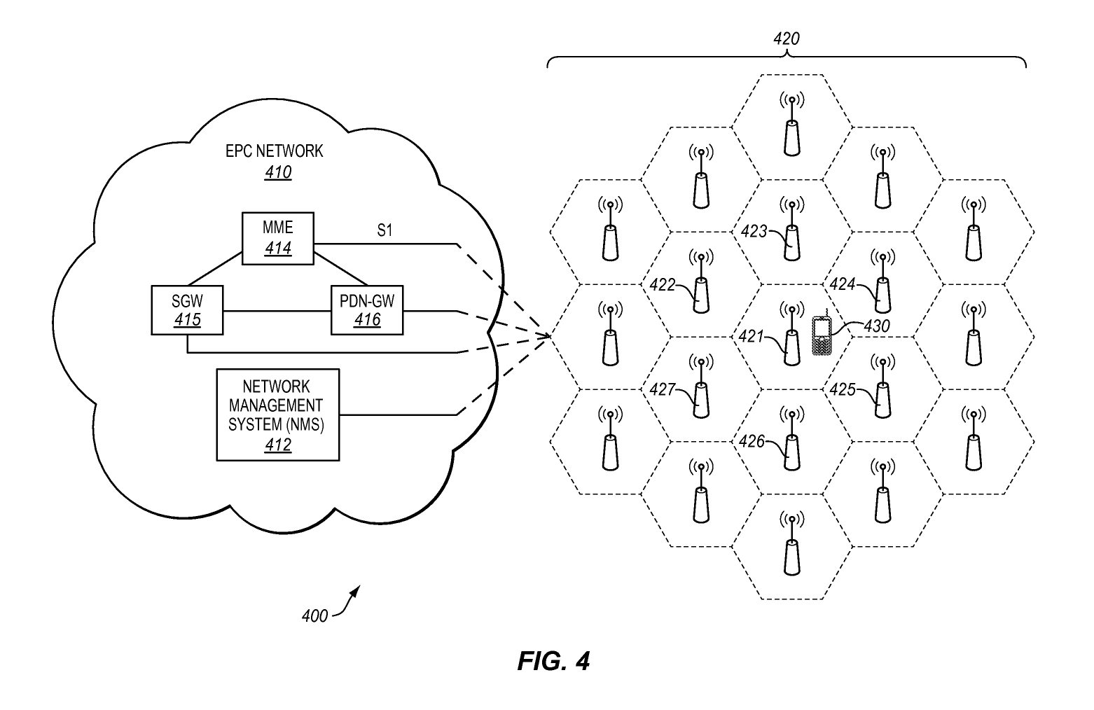

FIG. 4 illustrates an LTE network 400 in an exemplary embodiment. LTE network 400 is just one example of the mobile network 100 shown in FIG. 1. LTE network 400 includes an Evolved Packet Core (EPC) network 410 that is connected to a plurality of eNodeBs 420. LTE network 400 is able to provide 4G service to customers. Although not specifically shown in FIG. 4, one assumption is that LTE network 400 is overlaid on another type of network, such as a UMTS network. Thus, the LTE services co-exist with UMTS services, with the LTE network 400 considered as the overlay network while the UMTS network is considered the underlay network. The UMTS services may be provided by the same eNodeBs that provide the LTE services.

One or more end users have subscribed to 4G service through LTE network 400. The end users have mobile devices (referred to as User Equipment (UE)) that are equipped to receive 4G services from LTE network 400. The UEs are multi-mode or dual mode devices, meaning that the UEs are also able to receive wireless service from another type of network. In this example, the UEs are further equipped to receive wireless service from a UMTS network. One UE 430 is illustrated in FIG. 4 as an example.

EPC network 410 includes a network management system 412, a Mobility Management Entity (MME) 414, a serving gateway (SGW) 415, and a Packet Data Network Gateway (PDN-GW) 416. Network management system 412 is similar to the network management system 112 described in FIG. 1. In this example, network management system 412 may comprise an Operation, Administration, and Maintenance (OAM) system, which is a group of management functions that provide system or network fault indication, network configuration (including the neighbor eNodeBs lookup table), performance monitoring, security management, diagnostic functions, etc. An OAM system may also be referred to as an Operations Support System (OSS) and/or a Business Support System (BSS). MME 414 is responsible for tracking the location of UEs in LTE network 400 so that calls may be routed to the UEs, among other functionalities. SGW 415 routes and forwards user data packets between UEs in LTE network 400 and other 3GPP technology networks (3G or 2G networks). PDN-GW 416 provides bearer connectivity from UEs in the LTE network 400 to external packet data networks by being the point of entry or exit.

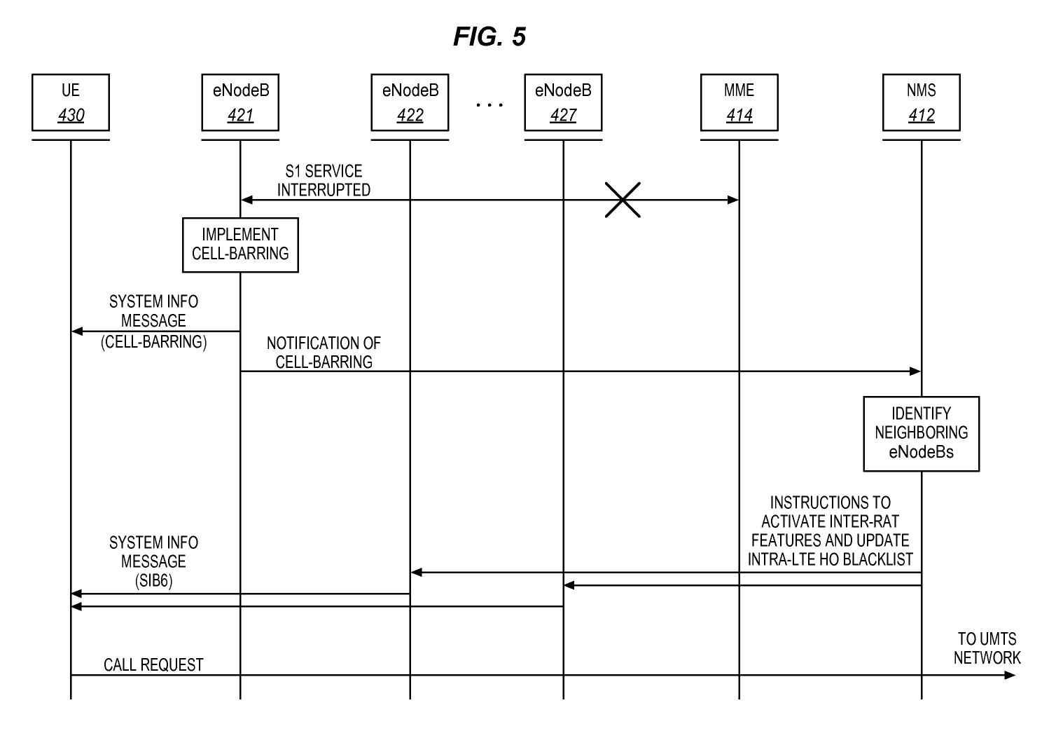

When an eNodeB in LTE network 400 triggers cell-barring, network management system 412 will activate inter-RAT features in neighboring eNodeBs. FIG. 5 is a message diagram illustrating activation of inter-RAT features in neighboring eNodeBs in an exemplary embodiment. Assume that communication between MME 414 and eNodeB 421 over the S1 interface becomes interrupted. When this occurs, eNodeB 421 may automatically trigger cell-barring. After invocation of cell-barring, eNodeB 421 announces its unavailability via Dynamic System Information Modification (DSIM) by broadcasting a System Information Message to UEs within its cells. In one exemplary embodiment, the System Information Message is of a SIB type 1 (SIB1) that is set to indicate that eNodeB 421 is barred for all types of mobile devices and all types of calls. As per TS 36.331, there is a delay between the time when eNodeB 421 triggers cell-barring with SIBs update and the time when mobile devices are able to re-acquire the updated type(s) of SIBs. eNodeB 421 also transmits a notification message to network management system 412 indicating that eNodeB 421 has triggered cell-barring.

Network management system (NMS) 412 receives the notification message from eNodeB 421 indicating that eNodeB 421 has triggered cell-barring. In response to the notification message, network management system 412 identifies one or more neighboring eNodeBs 422-427 for eNodeB 421. Network management system 412 then generates instructions to activate inter-RAT features and to update the intra-LTE HO blacklist in the neighboring eNodeBs 422-427 while eNodeB 421 is barred. One assumption is that inter-RAT features are not presently activated in all of neighboring eNodeBs 422-427. One reason may be due to the potential high cost of licensing fees. Another reason may be due to UE battery life consideration because activation of inter-RAT features on eNodeBs where their signal strengths are known to be excellent would only cause mobile devices to consume the battery for inter-RAT measurement purposes with little or no possibility of actually triggering LTE to inter-RAT mobility. Network management system 412 then transmits the instructions to the neighboring eNodeBs 422-427.

Each eNodeB 422-427 processes the instructions, and activates the inter-RAT features accordingly. As part of activating the inter-RAT features, eNodeB 422 broadcasts a System Information Message that is of a SIB type 6 (SIB6) to the mobile devices for the purposes of UMTS cell reselection and redirection/handover of wireless service from LTE network 400 to the underlay UMTS network (not shown). eNodeB 422 achieves the latter by including the blacklist in the broadcast for mobile devices in idle mode, by adding the barred cell IDs to the blacklist when setting up dedicated intra-LTE HO measurement configurations with mobile devices in connected mode, and by setting up dedicated inter-RAT measurement configurations with the same connected mobile devices, which can move toward any barred cell of eNodeB 421. Other neighboring eNodeBs 427 may broadcast similar System Information Messages and perform similar actions. The SIB6 data informs UE 430 that wireless service is available through the UMTS network. Thus, if UE 430 keeps moving toward any cell of eNodeB 421, the intra-LTE handover measurement configuration that was setup by eNodeB 422 for UE 430 will not meet the UE reporting criteria (because the cells of eNodeB 421 are in the blacklist), meaning no intra-LTE HO to eNodeB 421 can occur. Meanwhile, the inter-RAT measurement configuration that was setup by eNodeB 422 for UE 430 will meet the UE reporting criteria when UMTS cell signal becomes better than its LTE counterpart. When eNodeB 422 receives such a measurement report from UE 430, eNodeB 422 instructs UE 430 to initiate LTE-to-UMTS handover, which means that UE 430 will send a call request to the UMTS network. The wireless service available is 3G instead of 4G, which means the end user will experience a downgrade in service. However, the end user will at least have some type of wireless service available while eNodeB 421 is barred.

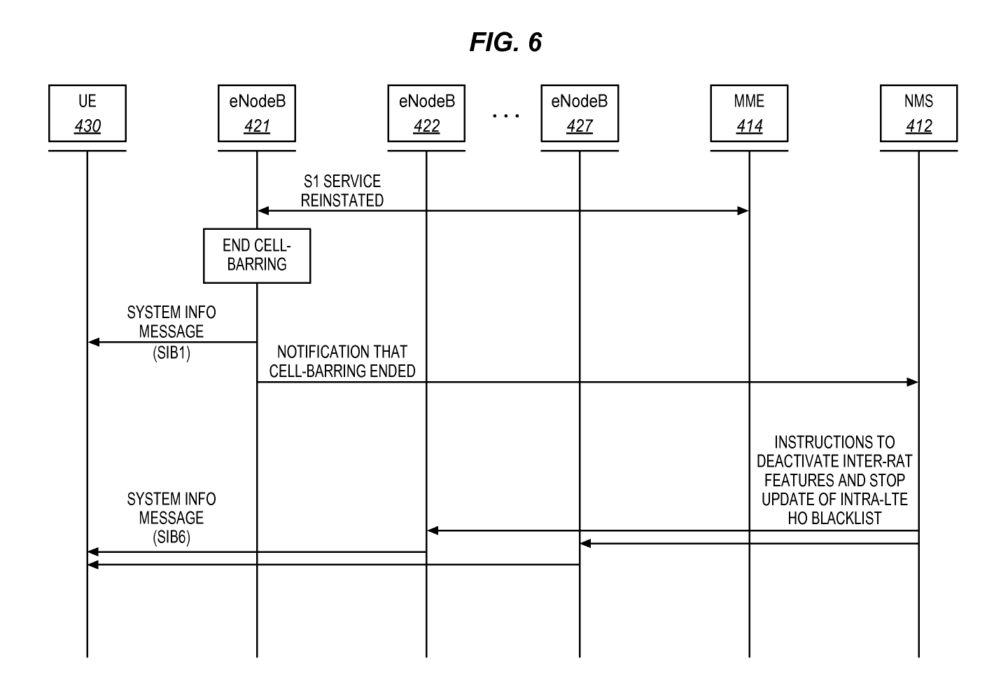

The inter-RAT features are activated temporarily in neighboring eNodeBs 422-427 while eNodeB 421 is barred. However, when eNodeB 421 is operational again (i.e., no longer out of service or cell-barred), eNodeB 421 will again send a notification message to network management system 412 indicating that eNodeB 421 is operational and is no longer out of service. Network management system 412 then deactivates the inter-RAT features in neighboring eNodeBs 422-427 as described in FIG. 6.

FIG. 6 is a message diagram illustrating deactivation of inter-RAT features and update of the intra-LTE HO blacklist in neighboring eNodeBs in an exemplary embodiment. Assume that communication between MME 414 and eNodeB 421 over the S1 interface is reinstated or recovered. When this occurs, eNodeB 421 ends cell-barring and again makes itself available for LTE service. eNodeB 421 announces its availability via DSIM by broadcasting a System Information Messages to UEs within its cells. In one exemplary embodiment, the System Information Message is of a SIB type 1 (SIB1) that is set to indicate that eNodeB 421 is available for all types of mobile devices and all types of calls. As per TS 36.331, there is a delay between the time when eNodeB 421 ends cell-barring with SIBs update and the time when mobile devices are able to re-acquire the updated type(s) of SIBs. eNodeB 421 also transmits a notification message to network management system 412 indicating that eNodeB 421 has ended cell-barring.

Network management system (NMS) 412 receives the notification message from eNodeB 421 indicating that eNodeB 421 has ended cell-barring. In response to the notification message, network management system 412 generates instructions to deactivate inter-RAT features and to revert the intra-LTE HO blacklist update in the neighboring eNodeBs 422-427. Network management system 412 then transmits the instructions to the neighboring eNodeBs 422-427.

Each eNodeB 422-427 processes the instructions, and deactivates the inter-RAT features accordingly. As part of deactivating the inter-RAT features, eNodeB 422 uses DSIM by broadcasting updated System Information Messages within its cells. The System Information Message that is of a SIB type 6 (SIB6) for UMTS cell reselection may be excluded, and the cell IDs of eNodeB 421 are no longer in the blacklist when eNodeB 422 sets up dedicated intra-LTE HO measurement configurations with connected mobile devices or when eNodeB 422 broadcasts the blacklist information. Other neighboring eNodeBs 427 may similarly broadcast updated System Information Messages and perform similar actions. As a result, UE 430 may again receive 4G service through LTE network 400 because each eNodeB 422-427 has stopped adding eNodeB 421 cell IDs in the blacklist when setting up intra-LTE measurement configuration with UE 430, and stopped setting up inter-RAT measurement configuration with the same mobile device (if the inter-RAT features were previously deactivated).

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
an interface system operable to receive a notification message from a base station of a mobile network that the base station is out of service; and
a control system operable to identify other base stations that are neighbors of the base station which is out of service, and to generate instructions to activate inter-Radio Access Technology (inter-RAT) features in the neighboring base stations while the base station is out of service;
the interface system is further operable to transmit the instructions to the neighboring base stations to activate the inter-RAT features.

2. The system of claim 1 wherein:
the control system is further operable to generate instructions to update an intra-network handover blacklist for mobile devices by adding cell identifiers of the base station which is out of service.

3. The system of claim 1 wherein:
the mobile network comprises a Long Term Evolution (LTE) network; and
the instructions include commands to broadcast a System Information Message to the mobile devices that is of a System Information Block type 6 (SIB6) set to redirect wireless service to a UMTS network.

4. The system of claim 1 wherein:
the mobile network comprises a Long Term Evolution (LTE) network; and
the instructions include commands to broadcast a System Information Message to the mobile devices that is of a System Information Block type 7 (SIB7) set to redirect wireless service to a GSM network.

5. The system of claim 1 wherein:
the mobile network comprises a Long Term Evolution (LTE) network; and
the instructions include commands to broadcast a System Information Message to the mobile devices that is of a System Information Block type 8 (SIB8) set to redirect wireless service to a CDMA network.

6. The system of claim 1 wherein:
the interface system is further operable to receive another notification message from the base station indicating that the base station is operational;
the control system is further operable to generate instructions to deactivate the inter-RAT features in the neighboring base stations; and
the interface system is further operable to transmit the instructions to the neighboring base stations to deactivate the inter-RAT features.

7. The system of claim 6 wherein:
the control system is further operable to generate instructions to update an intra-network handover blacklist for mobile devices by removing cell identifiers of the base station which is now operational.

8. The system of claim 1 wherein:
the control system is further operable to record a duration of time in which the inter-RAT features are activated in the neighboring base stations.

9. The system of claim 1 wherein:
the control system is further operable to record the number of neighboring base stations in which the inter-RAT features are activated.

10. A method comprising:
receiving a notification message from a base station of a mobile network that the base station is out of service;
identifying other base stations that are neighbors of the base station which is out of service;
generating instructions to activate inter-Radio Access Technology (inter-RAT) features in the neighboring base stations while the base station is out of service; and
transmitting the instructions to the neighboring base stations to activate the inter-RAT features.

11. The method of claim 10 further comprising:
generating instructions to update an intra-network handover blacklist for mobile devices by adding cell identifiers of the base station which is out of service.

12. The method of claim 10 wherein:
the mobile network comprises a Long Term Evolution (LTE) network; and
the instructions include commands to broadcast a System Information Message to the mobile devices that is of a System Information Block type 6 (SIB6) set to redirect wireless service to a UMTS network.

13. The method of claim 10 wherein:
the mobile network comprises a Long Term Evolution (LTE) network; and
the instructions include commands to broadcast a System Information Message to the mobile devices that is of a System Information Block type 7 (SIB7) set to redirect wireless service to a GSM network.

14. The method of claim 10 wherein:
the mobile network comprises a Long Term Evolution (LTE) network; and
the instructions include commands to broadcast a System Information Message to the mobile devices that is of a System Information Block type 8 (SIB8) set to redirect wireless service to a CDMA network.

15. The method of claim 10 further comprising:
receiving another notification message from the base station indicating that the base station is operational;
generating instructions to deactivate the inter-RAT features in the neighboring base stations; and
transmitting the instructions to the neighboring base stations to deactivate the inter-RAT features.

16. The method of claim 15 further comprising:
generating instructions to update an intra-network handover blacklist for mobile devices by removing cell identifiers of the base station which is now operational.

17. The method of claim 10 further comprising:
recording a duration of time in which the inter-RAT features are activated in the neighboring base stations.

18. The method of claim 10 further comprising:
recording the number of neighboring base stations in which the inter-RAT features are activated.

19. A system comprising:
a network management system for a Long Term Evolution (LTE) network;
the network management system operable to receive a notification message from an enhanced NodeB (eNodeB) that the eNodeB has implemented cell-barring;
the network management system is further operable to identify other eNodeBs that are neighbors of the barred eNodeB, to generate instructions to activate inter-Radio Access Technology (inter-RAT) features temporarily in the neighboring eNodeBs while the barred eNodeB is out of service, and to transmit the instructions to the neighboring eNodeBs to activate the inter-RAT features.

20. The system of claim 19 wherein:
the network management system is further operable to generate instructions to update an intra-LTE handover blacklist for mobile devices by adding cell identifiers of the barred eNodeB to the blacklist.
